(19) United States
(12) Patent Application Publication
(10) Pub. No.: US 2025/0176778 A1
(43) Pub. Date: Jun. 5, 2025

(54) EVACUATION STATION

(71) Applicant: iRobot Corporation, Bedford, MA (US)

(72) Inventors: Insun Hong, Concord, MA (US); Calvin Jinwon Lee, Los Angeles, CA (US); Ryan Mercier, East Hampton, CT (US)

(21) Appl. No.: 19/047,012

(22) Filed: Feb. 6, 2025

Related U.S. Application Data
(63) Continuation of application No. 17/201,244, filed on Mar. 15, 2021.

(51) Int. Cl. A47L 9/28; A47L 9/00; A47L 11/40; B60L 53/30

(52) U.S. Cl. CPC A47L 9/2873; A47L 9/0063; A47L 11/4025; A47L 11/4091; B60L 53/30; A47L 2201/022; A47L 2201/024

(57) ABSTRACT

A docking station for a mobile cleaning robot can include a base and a storage compartment. The base can be configured to receive the mobile cleaning robot. The base can include an electrical power interface configured to provide electrical power to the mobile cleaning robot. The storage compartment can be integrated with the base and the storage compartment can be sized and shaped to receive a user-replaceable accessory associated with the base or the mobile cleaning robot.

### RELATED APPLICATIONS

This application is a continuation of U.S. patent application Ser. No. 17/201,244, filed Mar. 15, 2021, the content of which is incorporated herein by reference in its entirety.

### BACKGROUND

Autonomous mobile robots include autonomous mobile cleaning robots that can autonomously perform cleaning tasks within an environment, such as a home. Many kinds of cleaning robots are autonomous to some degree and in different ways. Some robots can interface with a docking station automatically. The docking station can perform maintenance on the robot such as charging of batteries of the robot and evacuation of debris from a debris bin of the robot.

### SUMMARY

Mobile cleaning robots can include a variety of components that require replacement from time to time. For example, vacuuming robots include components such as a side brush, rollers, and an air filter that require service and replacement. Mopping robots require regular replacement of their components as well. For example, mopping pads (wet or dry) are often replaced after every mopping mission. Mopping robots also require filling of the robot with a cleaning solution, such as before every mopping mission commences. Further, evacuation stations for vacuuming robots may require regular replacement of bags within the debris bin of the evacuation station such as when the bags become full. Users who have one or more robots within their home may store various user-replaceable accessories, which can take a considerable amount of space. Also, user-replaceable accessories can be lost or misplaced, or not quickly findable when service is required.

This disclosure helps to address these issues by including a docking station with integrated storage. A storage compartment can be integrated into a charging station or can be integrated into an evacuation and charging station. For example, an evacuation station can include a storage compartment configured to store a spare bag, a spare side brush, or a spare filter. In some examples, the storage compartment can include one or more features to allow the user-replaceable accessories to fit within the compartment more easily or more efficiently. Integration of one or more storage compartments can provide a location for a user to store user-replaceable accessories to help limit loss of accessories and to take advantage of otherwise unused space in a docking or charging station.

The above discussion is intended to provide an overview of subject matter of the present patent application. It is not intended to provide an exclusive or exhaustive explanation of the invention. The description below is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1A illustrates an isometric view of a docking station and a mobile cleaning robot.

FIG. 1B illustrates a top isometric view of a portion of a docking station for a mobile cleaning robot.

FIG. 1C illustrates a top isometric view of a portion of a docking station for a mobile cleaning robot.

FIG. 2A illustrates an enlarged top isometric view of a docking station and a mobile cleaning robot.

FIG. 2B illustrates an enlarged top isometric view of a docking station and a mobile cleaning robot.

FIG. 3A illustrates an enlarged top isometric view of a docking station for a mobile cleaning robot.

FIG. 3B illustrates an enlarged top isometric view of a docking station for a mobile cleaning robot.

FIG. 4A illustrates an isometric view of a docking station for a mobile cleaning robot.

FIG. 4B illustrates an enlarged top isometric view of a docking station for a mobile cleaning robot.

FIG. 5A illustrates an enlarged isometric view of a docking station and a mobile cleaning robot.

FIG. 5B illustrates an enlarged isometric view of a docking station and a mobile cleaning robot.

FIG. 6 illustrates a perspective view of a docking station for a mobile cleaning robot.

FIG. 7A illustrates a perspective view of a docking station for a mobile cleaning robot.

FIG. 7B illustrates a perspective view of a docking station for a mobile cleaning robot.

FIG. 8A illustrates a perspective view of a docking station for a mobile cleaning robot.

FIG. 8B illustrates a perspective view of a docking station for a mobile cleaning robot.

FIG. 9A illustrates a front view of a docking station for a mobile cleaning robot.

FIG. 9B illustrates a perspective view of a docking station and a mobile cleaning robot.

FIG. 9C illustrates a side view of a docking station and a mobile cleaning robot.

FIG. 9D illustrates an enlarged perspective view of a docking station for a mobile cleaning robot.

FIG. 9E illustrates an enlarged perspective view of a docking station for a mobile cleaning robot.

FIG. 10A illustrates a front view of a docking station for a mobile cleaning robot.

FIG. 10B illustrates a perspective view of a docking station and a mobile cleaning robot.

FIG. 11 illustrates a perspective view of a docking station for a mobile cleaning robot.

FIG. 12 illustrates a perspective view of a docking station for a mobile cleaning robot.

FIG. 13 illustrates a perspective view of a docking station for a mobile cleaning robot.

FIG. 14A illustrates a side view of a docking station for a mobile cleaning robot.

FIG. 14B illustrates a perspective view of a docking station and a mobile cleaning robot.

FIG. 14C illustrates an enlarged perspective view of a docking station for a mobile cleaning robot.

FIG. 15A illustrates a perspective view of a docking station and a mobile cleaning robot.

FIG. 15B illustrates a perspective view of a docking station for a mobile cleaning robot.

### DETAILED DESCRIPTION

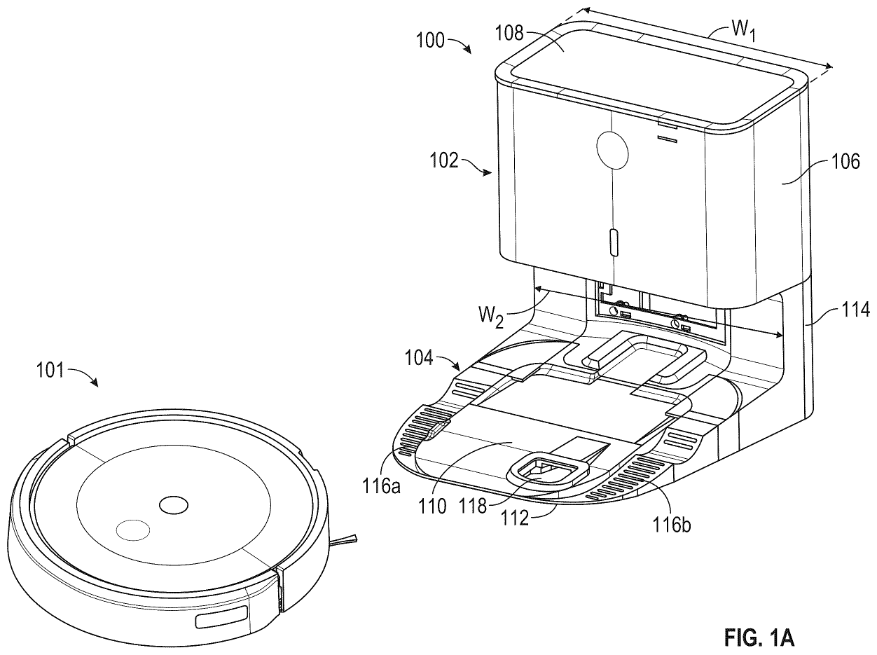

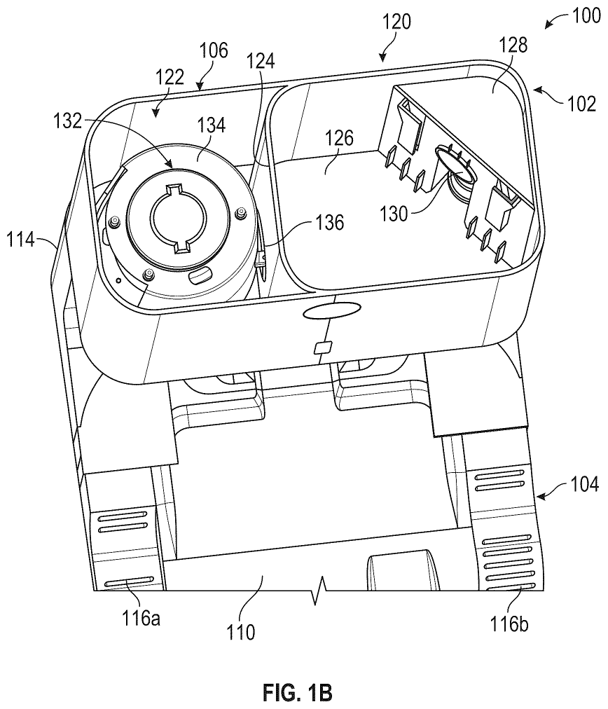

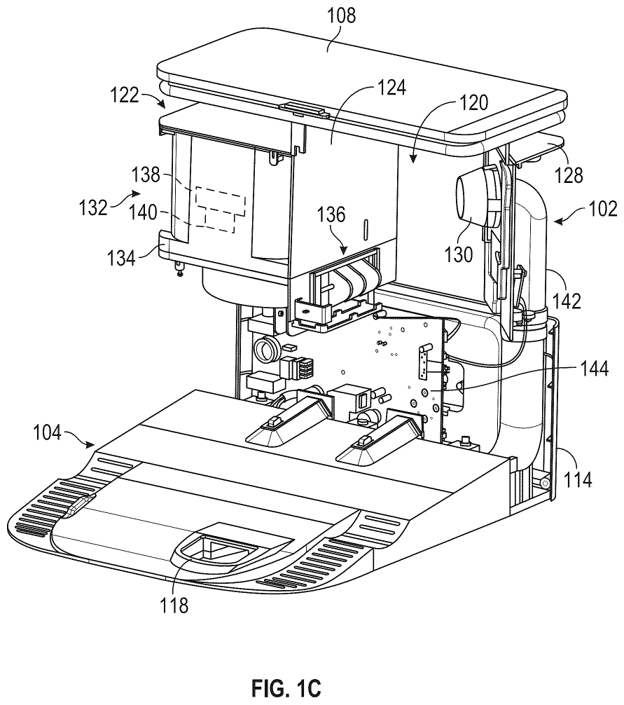

FIG. 1A illustrates an isometric view of a docking station 100 for a mobile cleaning robot 101. FIG. 1B illustrates a top isometric view of a portion of the docking station 100. FIGS. 1A and 1B are discussed together below.

The docking station 100 can include a canister 102 and a base 104. The canister 102 can include an outer wall 106 and a lid 108 (as shown in FIG. 1A). The base 104 can include a platform 110 having a front portion 112 and a rear portion 114. The base can also include tracks 116a and 116b and a vacuum port 118. As shown in FIG. 1B, the canister 102 can include a debris bin 120, a fan compartment 122, and a side wall 124. The debris bin 120 can include a bottom wall 126 (or floor), a bag support 128, and a vacuum inlet 130. The canister 102 can also include a fan system 132 including a fan housing 134. FIG. 1A also shows widths w1 and w2 and orientation indicators Top, Bottom, Front, and Back.

The components of the docking station 100 can be rigid or semi-rigid components made of materials such as one or more of metals, plastics, foams, elastomers, ceramics, composites, combinations thereof, or the like. Materials of some components are discussed in further detail below. The mobile robot 101 can be a mobile cleaning robot including wheels, extractor, a debris bin, a controller, and various sensors. The robot 101 can be configured to perform autonomous cleaning missions or routines within an environment.

The base 104 can be a ramped member including the platform 110 and the tracks 116a and 116b, which can be configured to receive the mobile cleaning robot 101 thereon for maintenance, such as charging and emptying debris from the mobile cleaning robot. The tracks 116 can be configured to receive wheels of the robot 101 to guide the robot 101 onto the base 104 for charging and debris evacuation using contacts 115. The contacts 115 can be an electrical power interface configured to provide electrical power to the mobile cleaning 101. The front portion 112 can be opposite the back portion 114, which can connect to the canister 102. The platform 110 and the tracks 116 can be sloped toward the front portion 112 to help allow the mobile robot 101 to dock on the station 100.

When the robot 101 is positioned on the base 104, such as when wheels of the robot 101 are in wheel wells of the tracks, the vacuum port 118 can be aligned with a vacuum outlet of the robot 101. The vacuum port 118 can extend through the base 104 and can connect to the vacuum inlet of the debris bin 120.

The canister 102 can be an upper portion of the docking station 100 connected to the rear portion 114 of the base 104 and can extend upward therefrom, such that the canister 102 can be located at least partially above the base 104. The outer wall 106 of the canister 102 can have a shape of a substantially rectangular hollow prism with rounded corners where the outer wall 106 can define a top portion of the canister 102 that is open. The outer wall 106 can at least partially enclose the debris bin 120 and the fan compartment 122. A top portion of the canister 102 can have a width w1 that is about the same, or substantially the same, as a width w2 of the back portion 114 of the base 104, which can help to reduce a height of the docking station, which can allow the docking station to be positioned under furniture having a lower clearance.

The lid 108 can be connected to the outer wall 106 (such as by hinges or other fasteners), such as at a rear portion of the lid 108. The lid 108 can be releasably securable to the outer wall 106, such as at a front portion of the lid 108 and the outer wall 106 (such as via a friction/interference fit, latch, or the like). Removal of the lid 108 or opening of the lid 108 from the top portion of the canister 102 can provide access to both the fan compartment 122 and the debris bin 120.

The fan compartment 122 can be formed at least in part by the outer wall 106 and the side wall 124. The side wall 124 can be a substantially vertical wall extending between the floor 126 and the lid 108. The fan compartment 122 can be connected to the debris bin 120 by the side wall 124 such that the fan compartment 122 is adjacent to the debris bin 120 and such that the fan compartment 122 is offset from a central axis of the base 104 (as is the debris bin 120). The fan compartment 122 can support the fan system 132 therein, which can be pneumatically connected to the debris bin 120 via a fan port 136 extending through the side wall 124. That is, air can flow from the debris bin 120 through the fan port 136 and into the fan compartment 122, as motivated by the fan system 132. The fan system 132 can include the fan housing 134, which can contain the fan (such as an impeller and a motor of the fan system 132).

The bottom wall 126 (or floor) of the debris bin, the outer wall 106, and the side wall 124 can together define a volume of the debris bin 120. The lid 108 can also define the volume when the lid 108 is secured to the canister 102. The bag support 128 can be connected to the floor 126 and the outer wall 106 and can be configured to support a vacuum bag within the debris bin 120 where the bag can be pneumatically connected to the vacuum inlet 130 to connect the bag to the vacuum port 118 (and to the mobile robot 101 when the mobile robot 101 is in a docked position).

FIG. 1C illustrates a top isometric view of a portion of the docking station 100 for the mobile cleaning robot 101. The docking station 100 can be consistent with the docking station 100 shown in FIGS. 1A and 1B; FIG. 1C shows the docking station 100 with a front panel of the base removed and the outer wall 106 of the canister 102 removed.

FIG. 1C shows that the fan system 132 can include an impeller 138 and a motor 140 within the fan housing 134. The motor 140 can be operable to motivate or drive the impeller 138 to move air such as from the inlet port 118 through a vacuum duct 142 of the base 104 and the canister 102 through the vacuum inlet 130 and into a bag in the debris bin 120. The air can then be drawn through the bag and through the fan port 136 and into the fan housing 134 and can be discharged or ejected through the outer wall 106. FIG. 1C also shows a circuit board 144 that can be connected to the base 104, such as the rear portion 114 of the base 104. The circuit board 144 can connect to electrical components within the canister 102, such as a bag sensor, the motor 140, etc.

Optionally, the docking station 100 can include one or more storage compartments for storing a user-replaceable accessory associated with the base 104, the canister 102, or the mobile cleaning robot 101. Various examples are discussed in detail below with respect to several examples or embodiments where like numerals between examples can represent like components.

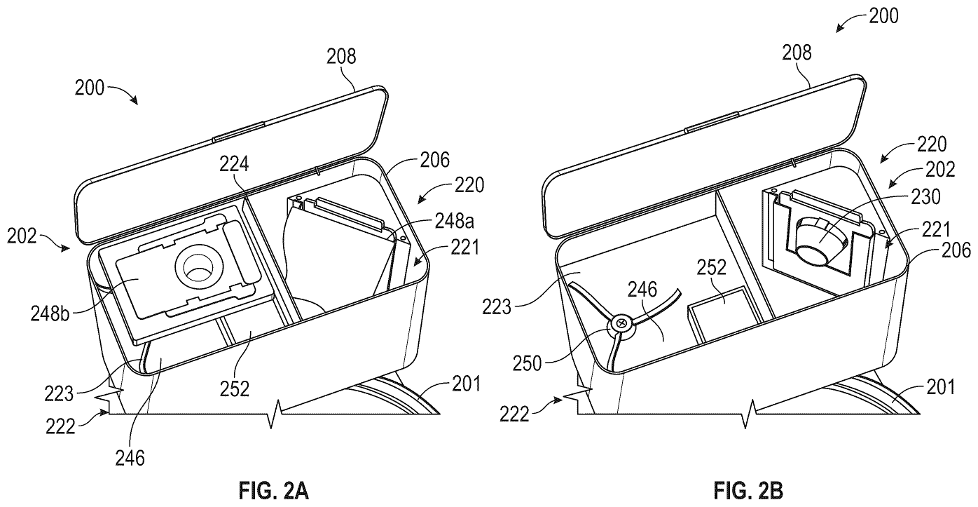

FIG. 2A illustrates an enlarged top isometric view of a docking station 200 and a mobile cleaning robot 201. FIG. 2B illustrates an enlarged top isometric view of the docking station 200 and the mobile cleaning robot 201. FIGS. 2A and 2B are discussed together below. The docking station 200 can be similar to the docking station 100 discussed above. Any of the docking stations discussed above or below can be modified to include the features of the docking station 200. The docking station 200 can differ in that the docking station 200 can include a storage compartment above its fan compartment.

For example, the docking station 200 can include a storage compartment 223 above a fan compartment 222 and adjacent or near a debris bin 220 in a canister 202. The debris bin 220 can include a bag compartment 221. The storage compartment 223 can be defined, at least in part by a tray 246. The tray 246 can be a rigid or semi-rigid member connected to an outer wall 206 of the canister 202. The tray 246 can also be connected to one or more components of the fan compartment 222 and can be connected to a side wall 224.

The tray 246 can be optionally integrated with the base or canister 202 and can be open toward a top portion of the canister 202. The tray 246 can be configured to receive (such as sized and shaped) a user-replaceable accessory associated with a base (e.g., base 104), the canister 202, or the mobile cleaning robot 201. For example, the tray 236 can be substantially rectangularly shaped and can have a relatively small thickness to help maximize the distance between the tray 246 and the lid 208 to help maximize volume of the storage compartment 223.

As shown in FIG. 2A, the tray 246 can support a spare bag 248b, which can be used to replace the bag 248a of the debris bin 220. As shown more clearly in FIG. 2B, the tray 246 can also be configured to receive and store a side brush 250, which can be a user-replaceable component of the mobile cleaning robot 201. Similarly, the tray 246 can receive a filter 252, which can be a user-replaceable component of the mobile cleaning robot 201. The tray 246 can be configured to support or receive one or more components such as a side brush, a filter, a cleaning pad, cleaning solution, a roller, an evacuation bag, maintenance tools or utensils, or the like. Examples of a roller, side brush, and other replaceable components of the robot 201 are shown in U.S. application Ser. No. 16/805,274, which is incorporated by reference herein, in its entirety.

The lid 208 can be hingeably connected to the outer wall 206 (as described above) and can be movable between an open position (shown in FIGS. 2A and 2B) and a closed position. In the open position, the lid 208 can provide access to the storage compartment 223 (and the tray 246) and user-replaceable accessories located therein. Such a compartment can provide a location for a user to store user-replaceable accessories to help limit loss of accessories and to take advantage of otherwise unused space in the canister 202.

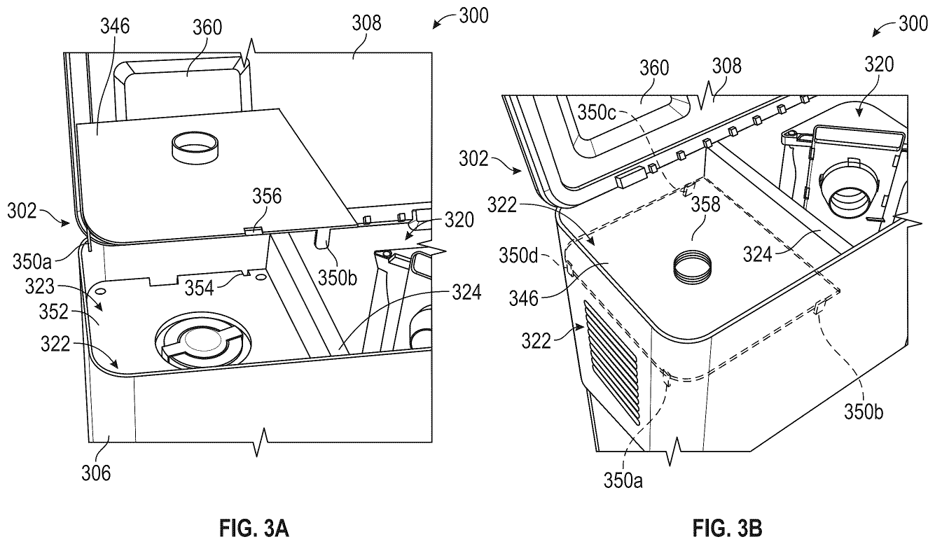

FIG. 3A illustrates an enlarged top isometric view of a docking station 300 for a mobile cleaning robot. FIG. 3B illustrates an enlarged top isometric view of the docking station for a mobile cleaning robot 300. FIGS. 3A and 3B are discussed together below. The docking station 300 can be similar to the docking stations 100-200 discussed above. Any of the docking stations discussed above or below can be modified to include the features of the docking station 300. The docking station 300 can differ in that the docking station 300 can include a removable tray and features for supporting user-replaceable accessories.

For example, a tray 346 of a storage compartment 323 of a canister 302 can be removably securable to a fan compartment 322. That is, the tray 346 can be removed from the fan compartment 322, as shown in FIG. 3A. The tray 346 can include tabs 350a-350d that can extend from a platform of the tray 346 to connect to a lid or cover 352 of the fan compartment 322. Optionally, the tabs 350a-350d can be insertable into slots or openings (e.g., 354) of the cover 352 to secure the tray 346 to the cover 352. Optionally, the tabs 350a-350d can include fingers or teeth for securing the tabs 350 to the cover 352, such as via a snap interface between the tabs 350 and the cover 352.

The tray 346 can also include a notch 356, which can be a notch or slot in the tray 346, such as at a periphery of the tray 346. The notch 356 can be configured to receive a tool therein (e.g., a small standard or flat head screw driver) for prying of the tray 346 to disengage the tabs 350 from the openings 354 of the cover 352 of the fan compartment 322, such as to allow the tray to be removed for service to be performed on one or more components of the fan compartment 322. Optionally, a notch can be included in an inner face of an outer wall 306 of the canister where the tray 346 engages the outer wall 306 when connected to the cover 352. Such a notch in the outer wall 306 can also allow for removal of the tray 346 from the fan compartment 322.

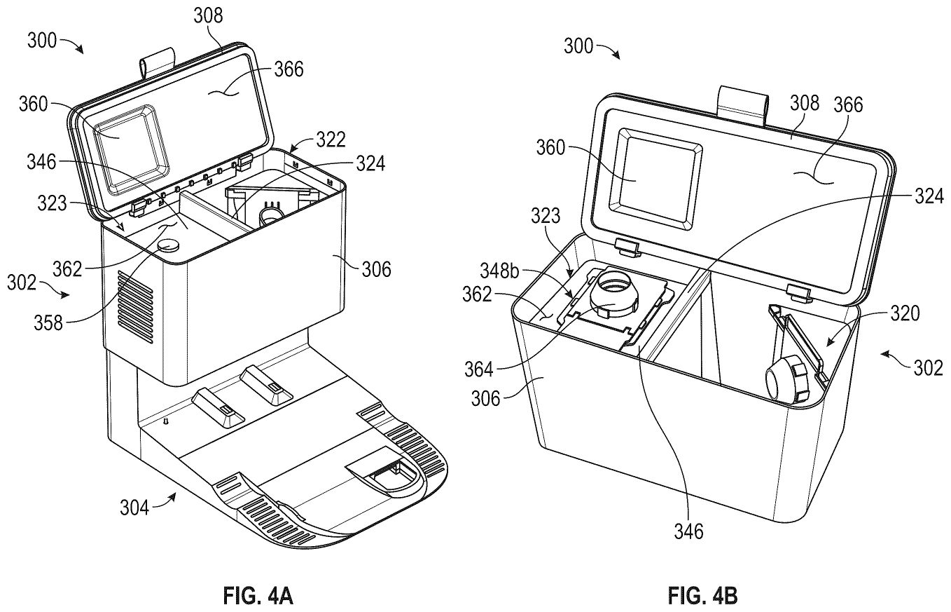

The tray 346 can also include a projection or boss 358 and the lid 308 can include a recess 360, which can work together to receive a user-replaceable component of the cannister 302, such as a replacement bag, as discussed in further detail with respect to FIGS. 4A and 4B.

FIG. 4A illustrates an isometric view of the docking station 300 for a mobile cleaning robot. FIG. 4B illustrates an enlarged top isometric view of the docking station 300 for a mobile cleaning robot. FIGS. 4A and 2B are discussed together below. The docking station 300 can be similar to the docking stations 300 discussed above with reference to FIGS. 3A and 3B; further details are discussed with respect to FIGS. 4A and 4B.

For example, FIG. 4A shows that the tray 346 can include the projection 358. The projection 358 can extend from an upper surface 362 of the tray 346 toward the opening defined by the outer wall 306 (and toward the lid 308 when the lid 308 is in the closed position). The projection 358 can be circular (from a top perspective), as shown in FIG. 4A, but can be other shapes in other examples, such as triangular, rectangular, square, hexagonal, or the like.

As shown in FIG. 4B, the projection 358 can be configured (e.g., sized and shaped) to engage an internal portion of a cone 364 of a replacement bag 348b. The projection 358 can help to guide a user to place the cone 364 of the replacement bag 348b in a proper or efficient location on the tray 346. Engagement of the projection 358 and the cone 364 can help to orient the bag 348 in a preferred orientation in the storage compartment 323, which can help to ensure that the lid 308 can be closed when the replacement bag 348b is in the storage compartment 323. The recess 362 can further help in this regard.

More specifically, the lid 308 can include the recess 360 in a lower surface 366 of the lid 308. The recess 360 can extend upward into the lower surface 366 to create a cavity or recess in the lid 308. The recess 360 can be located in the lid 308 such that it is positioned over the projection 358 of the tray 346 of the storage compartment 323 when the lid 308 is in the closed position. The recess 360 can have a square or rectangular profile or shape, but can have other shapes in other examples.

The recess 360 can be configured to receive at least a portion of the replacement accessory (such as the cone 364 of the replacement bag 348b) when the replacement bag 348b is in the storage compartment and when the replacement bag 348 is oriented by engagement of the projection 358 and the cone 364 and when the lid 308 is in the closed position. In this way, the projection 358 and lid recess 360 can work together to allow a replacement bag to be stored within the storage compartment 323 even when the storage compartment 323 is relatively shallow.

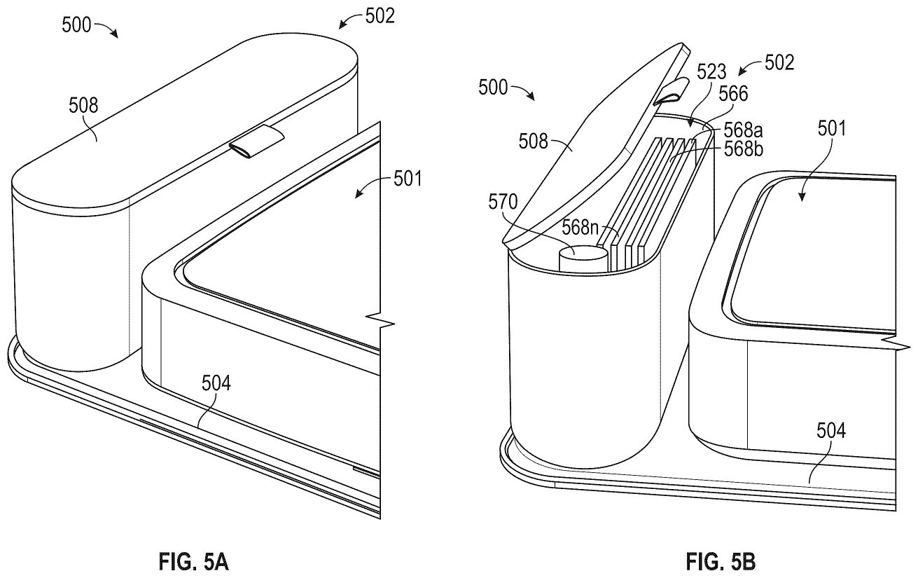

FIG. 5A illustrates an enlarged isometric view of a docking station 500 and a mobile cleaning robot 501. FIG. 5B illustrates an enlarged isometric view of the docking station 500 and the mobile cleaning robot 501. FIGS. 5A and 5B are discussed together below. The docking station 500 can be similar to the docking stations 100-300 discussed above. Any of the docking stations discussed above or below can be modified to include the features of the docking station 500. The docking station 500 can differ in that the docking station 500 can be configured to receive a mopping robot and to store features for such a robot.

For example, the mobile cleaning robot 501 can be a mopping robot, such as an autonomous mobile cleaning robot capable of performing wet or dry mopping operations or missions. Optionally, the mobile cleaning robot 501 can perform both mopping and vacuuming functions or operations, such that the robot 501 is a two-in-one type autonomous mobile cleaning robot.

The docking station 500 can include a base 504 and a canister 502. The base 504 can include features (such as contacts) for charging the robot 501. The canister 502 can include an outer wall 506 defining a cavity 566 therein. The cavity 566 can be open to a top of the canister 502. The canister 502 can also include a lid 508 that can be connected to a top portion of the outer wall 506. The lid 508 can be movable between an open position and a closed position such that the cavity 566 of the cannister 502 is accessible when the lid 508 is in the open position.

The cavity 566 can be part of a storage compartment 523 of the docking station 500, where the storage compartment 523 can be configured to receive and store one or more user-replaceable components of the mobile cleaning robot 501 or the docking station. For example, the storage compartment 523 can be configured to store mopping pads 568a-568n therein. The mopping pads 568 can be wet mopping pads or dry mopping pads (such as replacement pads) for securing to the mobile cleaning robot 501 for performing mopping operations. The storage compartment 523 and the cavity 560 can be configured (e.g., sized and shaped) to support the mopping pads 568 in an upright configuration. For example, the storage compartment 523 can include slots (or other retaining features) to orient the mopping pads 568 in the compartment 523.

The storage compartment 523 can also be configured (e.g., sized and shaped) to receive one or more containers (e.g., bottles) of cleaning solution 570 therein. The storage compartment 523 and the cavity 560 can be configured (e.g., sized and shaped) to support the container 570 in an upright configuration. For example, the storage compartment 523 can include slots, channels, or other retaining or orienting features to orient the container 570 in the compartment 523. The storage compartment 523 can be configured to store additional or alternative components, such as rollers, wheels, pads, cleaning solution, brushes, bags, or the like.

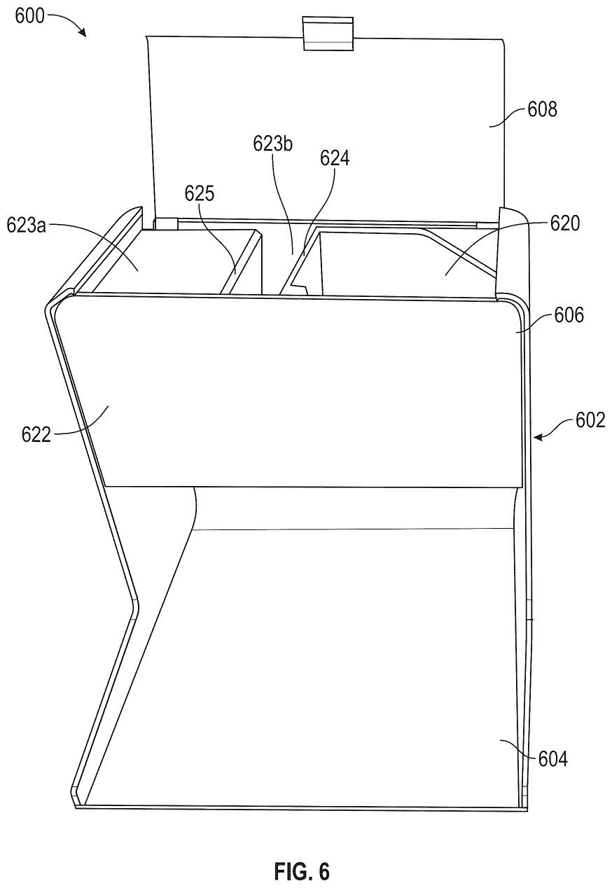

FIG. 6 illustrates a perspective view of a docking station for a mobile cleaning robot. The docking station 600 can be similar to the docking stations 100-300 or 500 discussed above. Any of the docking stations discussed above or below can be modified to include the features of the docking station 600. The docking station 600 can differ in that the docking station 600 can include a second storage compartment.

For example, the docking station 600 can include a cannister 602 connected to a base 604 where the cannister 602 can include an outer wall 606 defining compartments, such as a debris bin or compartment 620, a fan compartment 622, and storage compartments 623a and 623b. The storage compartment 623a can be located above the fan compartment 622 (similar to the storage compartments 223 and 323 discussed above). The storage compartment 623a can be configured to receive user-replaceable components, such as a side brush, debris bag, or the like.

The cannister 602 can also include a second storage compartment 623b, which can be defined at least in part by the outer wall 606 and inner walls 624 and 625 such that the storage compartment 623b is located between the debris bin 620 and the storage compartment 623a. Optionally, the storage compartment 623b can be relatively deep, which can allow for storage of longer components, such as rollers, or storage of bags in an upright orientation. Optionally, the inner wall 624 can be removable or adjustable within or with respect to the outer wall 606 to change a size or shape of the compartment 623b within the cannister 602, such as to optimize the storage compartment 623b for the user-replaceable accessory stored therein.

The storage compartments 623 and 623b can be configured to store additional or alternative components, such as rollers, wheels, pads, cleaning solution, brushes, bags, or the like.

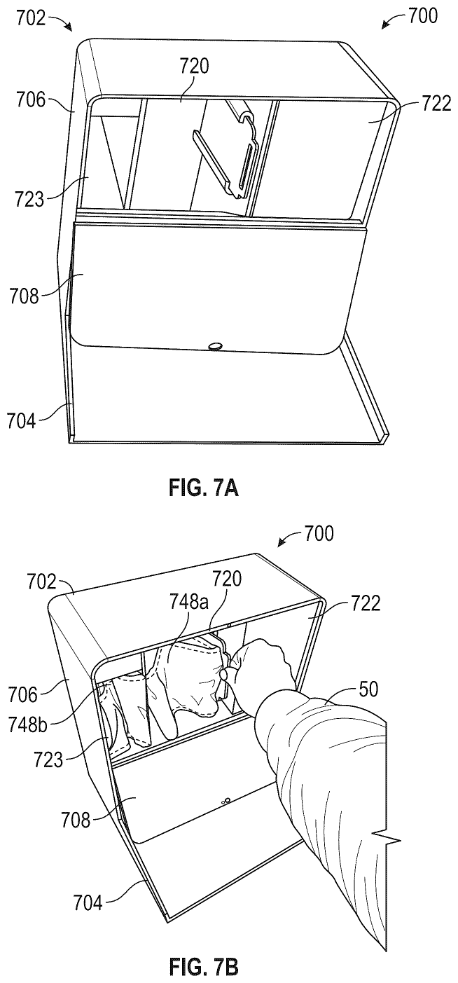

FIG. 7A illustrates a perspective view of a docking station 700 for a mobile cleaning robot. FIG. 7B illustrates a perspective view of the docking station 700 for a mobile cleaning robot. FIGS. 7A and 7B are discussed together below. The docking station 700 can be similar to the docking stations 100-300 and 500-600 discussed above. Any of the docking stations discussed above or below can be modified to include the features of the docking station 700. The docking station 700 can differ in that the docking station 700 can include a lid that opens toward a front of the docking station.

For example, the docking station 700 can include a cannister 702 connected to a base 704 where the cannister 702 can include an outer wall 706 defining compartments, such as a debris bin or compartment 720, a fan compartment 722, and a storage compartment 723. The storage compartment 723 can be located next to the debris compartment 720 and can be configured to receive user-replaceable components, such as a side brush, debris bag, or the like.

The storage compartment 723 and the debris bin 722 can be accessible when a lid 708 is in an open position. The lid 708 can be connected to a front portion of the outer wall 706 such that the lid 708 opens toward a front orientation of the docking station 700 or such that the lid 708 opens toward the base 704. The lid 708 can be hingeably connected to the outer wall 706 at a bottom portion of the lid 708 such that a user 50 does not have to hold the lid open to remove a bag 748a from the debris bin 720 or to remove a bag 748b from the storage compartment 723, such as for installation in the debris bin 720. The storage compartment 723 can be configured to store additional or alternative components, such as rollers, wheels, pads, cleaning solution, brushes, bags, or the like.

In other examples, the lid 708 can be located on a back portion or side portion of the outer wall 706 of the canister, as discussed in examples below. Optionally, the canister 702 can include multiple lids. For example, the lid 708 can be openable to access the debris bin 720 and a second lid can be located on a back or side of the canister for access to the storage compartment 723.

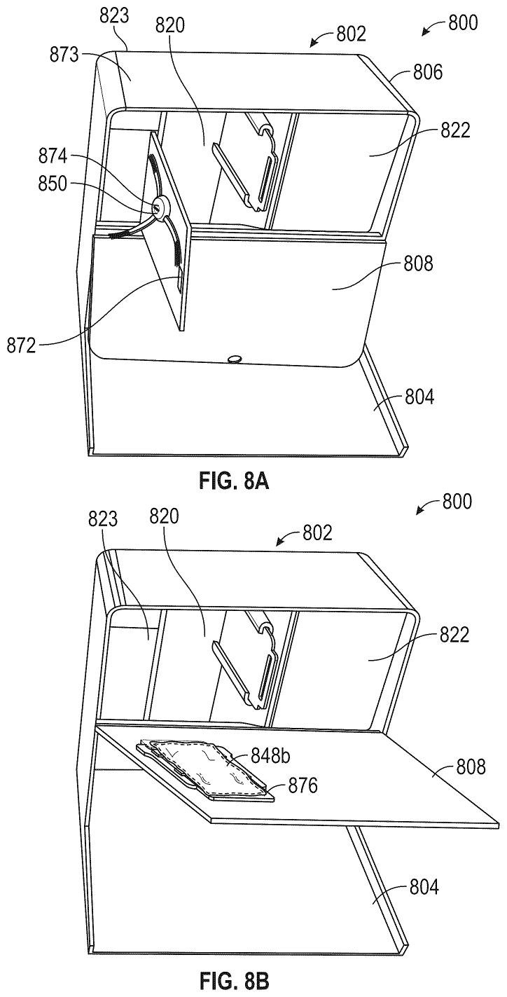

FIG. 8A illustrates a perspective view of a docking station 800 for a mobile cleaning robot. FIG. 8B illustrates a perspective view of the docking station 700 for a mobile cleaning robot. FIGS. 8A and 8B are discussed together below. The docking station 800 can be similar to the docking stations 100-300 and 500-700 discussed above. Any of the docking stations discussed above or below can be modified to include the features of the docking station 800. The docking station 800 can differ in that the docking station 800 includes a lid that opens to the front and that includes additional storage components.

The docking station 800 can include a cannister 802 connected to a base 804 where the cannister 802 can include an outer wall 806 defining compartments, such as a debris bin or compartment 820, a fan compartment 822, and a storage compartment 823. The storage compartment 823 can be located next to the debris compartment 820 and can be configured to receive user-replaceable components, such as a side brush, debris bag, or the like.

The storage compartment 823 and the debris bin 822 can be accessible when a lid 808 is in an open position. The lid 808 can be connected to a front portion of the outer wall 806 such that the lid 808 opens toward a front orientation of the docking station 800 or such that the lid 808 opens toward the base 804. The lid 808 can be hingably connected to the outer wall 806 at a bottom portion of the lid 808 such that a user 50 does not have to hold the lid open to access the storage compartment 823, such as for installation in the debris bin 820.

The docking station 800 can also include additional storage features. For example, as shown in FIG. 8A, the docking station 800 can include a tray 872. The tray 872 can be a relatively thin member slidably insertable into the storage compartment 823. Optionally, the tray 872 can include a projection 874 extending from the tray 872. The projection 874 can be a boss, hook, post, or other feature extending from the tray 872 such that the projection 874 can be configured to engage and support a user-replaceable component such as a side brush 850. Optionally, the tray 872 can include a connector 873, which can be a clip, a magnet, or other component configured to releasably secure the tray 872 to the canister, such as in the storage compartment 823. For example, the connector 873 (such as a magnet) can be magnetically securable to a magnet within the canister 802 to secure the tray 872 to the cannister 802.

As shown in FIG. 8B, the docking station 800 can include a retaining feature 876 on the lid 808. The storage feature 876 can be one or more projections, slots, pockets, or the like configured to receive and retain a user-replaceable component, such as the replacement bag 848b. The storage feature 876 can be located on the lid 808 such that the replacement bag 848b can be positioned into the storage compartment 823 or the debris bin 820 when the lid 808 is in the closed position. In this way, multiple user-replaceable components can be stored in the canister 802. The tray 872 and storage feature 876 can be configured to store additional or alternative components, such as rollers, wheels, pads, cleaning solution, brushes, bags, or the like.

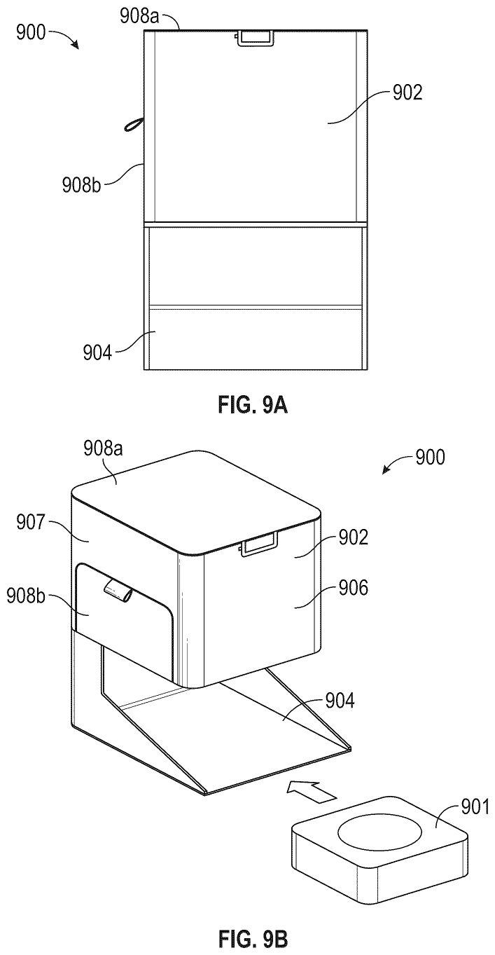

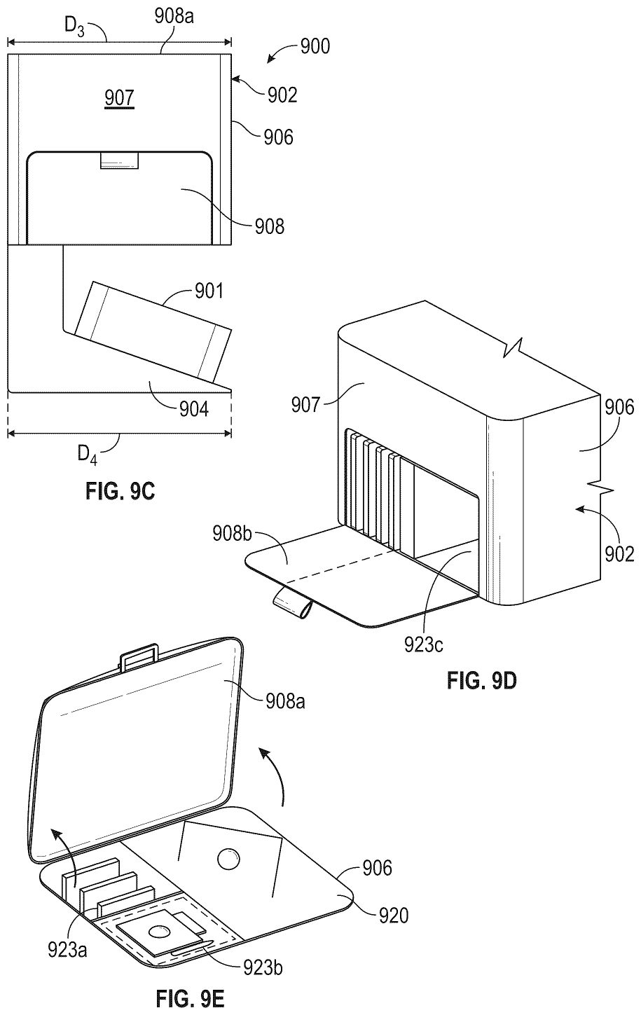

FIG. 9A illustrates a front view of a docking station 900 for a mobile cleaning robot 901. FIG. 9B illustrates a perspective view of the docking station 900 and the mobile cleaning robot 901. FIG. 9C illustrates a side view of the docking station 900 and the mobile cleaning robot 901. FIG. 9D illustrates an enlarged perspective view of the docking station 900 for the mobile cleaning robot 901. FIG. 9E illustrates an enlarged perspective view of the docking station 900 for the mobile cleaning robot 901. FIGS. 9A-9E are discussed together below.

The docking station 900 can be similar to the docking stations 100-300 and 500-800 discussed above. Any of the docking stations discussed above or below can be modified to include the features of the docking station 900. The docking station 900 can differ in that the docking station 900 can include a second storage component on a side portion of the docking station. Optionally, the docking station 900 can include only a single storage compartment on a side of the docking station 900.

The docking station 900 can include a cannister 902 connected to a base 904 where the cannister 902 can include an outer wall 906 defining compartments, such as a debris bin or compartment 920, a fan compartment 922, and storage compartments 923a-923c. The base 904 can be configured to receive the mobile cleaning robot 901 thereon. A lid 908 can be connected to a top portion of the outer wall 906 such that the lid 908 opens upward. The storage compartments 923a and 923b can be next to each other and can be next to the debris bin 920. The storage compartments 923a and 923b and the debris bin 922 can be accessible when the lid 908 is in an open position. The storage compartments 923a and 923b can be configured to store additional or alternative components, such as rollers, wheels, pads, cleaning solution, brushes, bags, or the like.

As shown in FIGS. 9B and 9C, the canister 902 can include a second lid 908b on a side portion 907 of the outer wall 906. The second lid 908b can be hingeably connected to the outer wall 906 such that when the lid 908b is in a closed position, as shown in FIGS. 9B and 9C, the storage compartment 923c is closed or inaccessible. When the lid 908b is in an open position, as shown in FIGS. 9D, the storage compartment 923c can be open and accessible through the side portion 907 of the container. The storage compartment 923c can be isolated from the storage compartments 923a and 923b. The storage compartment 923c can be located directly below the storage compartments 923a and 923b. The storage compartment 923c can be configured to store additional or alternative components, such as rollers, wheels, pads, cleaning solution, brushes, bags, or the like.

Also, the cannister 902 can be enlarged to accommodate a larger storage compartment. For example, the canister 902 can be a shape of a square prism to increase a volume of the storage containers 923a-923c. Optionally, the cannister can have a depth D3 that is the same or similar to a depth D4 of the base 904 (and optionally similar to a depth of the robot 901).

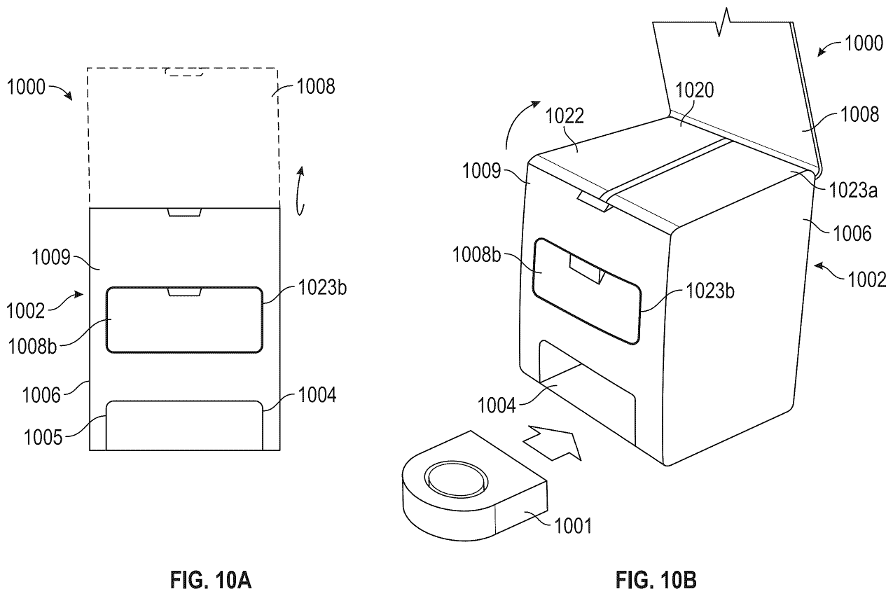

FIG. 10A illustrates a front view of a docking station 1000 for a mobile cleaning robot 1001. FIG. 10B illustrates a perspective view of the docking station 1000 and the mobile cleaning robot 1001. FIGS. 10A-10B are discussed together below. The docking station 1000 can be similar to the docking stations 100-300 and 500-900 discussed above. Any of the docking stations discussed above or below can be modified to include the features of the docking station 1000. The docking station 1000 can differ in that the docking station 1000 can include a second storage compartment in a front portion of the docking station 1000.

The docking station 1000 can include a cannister 1002 connected to a base 1004 where the cannister 1002 can include an outer wall 1006 defining compartments, such as a debris bin or compartment 1020, a fan compartment 1022, and a storage compartment 1023a. The base 1004 can be configured to receive the mobile cleaning robot 1001 therein or thereon. Optionally, the base 1004 can include a slot or be defined by a slot 1005 in the docking station. The slot 1005 can be sized and shaped to receive the robot 1001 therein, such as for charging and debris evacuation.

A lid 1008a can be connected to a top portion of the outer wall 1006 such that the lid 1008a opens upward. The storage compartment 1023a and the debris bin 1022 can be accessible when the lid 1008 is in an open position. The canister 1002 can include a second lid 1008b on a front portion 1009 of the outer wall 1006. The second lid 1008b can be hingeably connected to the outer wall 1006 such that when the lid 1008b is in a closed position, as shown in FIGS. 10A and 10B, the storage compartment 1023 is closed or inaccessible. When the lid 1008b is in an open position, the storage compartment 1023c can be open and accessible through the front portion 1009 of the cannister 1002. The storage compartments 1023a and 1023b can be configured to store additional or alternative components, such as rollers, wheels, pads, cleaning solution, brushes, bags, or the like.

Also, the docking station 1002 can be enlarged to accommodate a larger storage compartment. For example, the docking station 1002 can be a shape of a square prism to increase a volume of the storage containers 1023a and 1023b. Optionally, the docking station can have a shape of a rectangular prism.

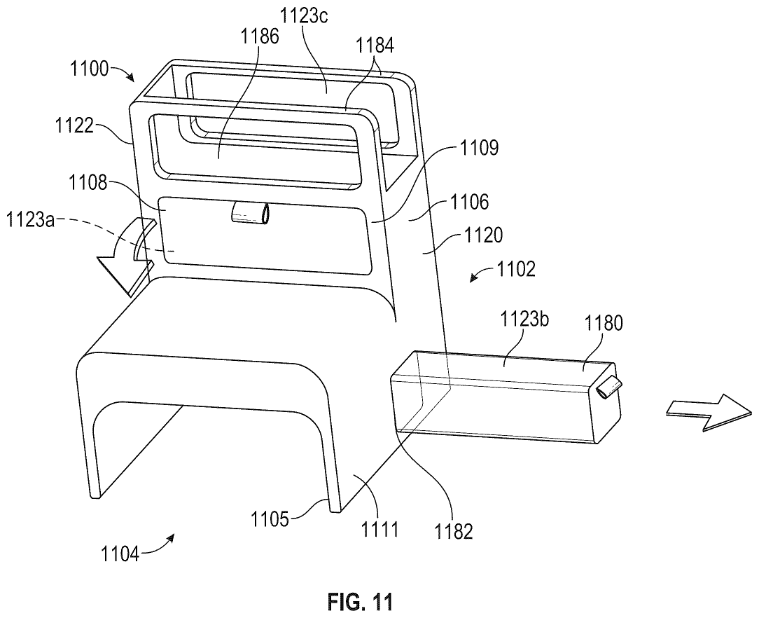

FIG. 11 illustrates a perspective view of a docking station 1100 for a mobile cleaning robot. The docking station 1100 can be similar to the docking stations 100-300 and 500-1000 are discussed above. Any of the docking stations discussed above or below can be modified to include the features of the docking station 1100. The docking station 1100 can differ in that the docking station 1100 can include multiple types of storage compartments.

The docking station 1100 can include a cannister 1102 connected to a base 1104 where the cannister 1102 can include an outer wall 1106 defining compartments, such as a debris bin or compartment 1120, a fan compartment 1122, and storage compartments 1123a-1123c. The base 1104 can be configured to receive the mobile cleaning robot 1104 therein or thereon. Optionally, the base 1104 can include a slot or be defined by a slot 1105 in the docking station. The slot 1105 can be sized and shaped to receive a robot therein, such as for charging and debris evacuation.

A lid 1108a can be connected to a front portion 1109 of the outer wall 1006 such that the lid 1108a opens forward or towards the base 1104. The storage compartment 1123a and the debris bin 1122 can be accessible when the lid 1108 is in an open position. The storage compartment 1123a can be configured to store user-replaceable components for the robot or the docking station 1100, such as rollers, wheels, pads, cleaning solution, brushes, bags, or the like.

The canister 1102 can also include a drawer 1180 on a side portion 1111 of the outer wall 1106. The drawer 1180 can be slidably removable from the canister 1102 and can be insertable into a slot 1182 for storage. When the drawer 1180 is removed from the slot 1182, the storage compartment 1123b can be accessible. The storage compartment 1123b can be configured to store user-replaceable components for the robot or the docking station 1100, such as rollers, wheels, pads, cleaning solution, brushes, bags, or the like. The drawer 1180 can include a knob, tab, handle, or the like for opening and closing the drawer 1180.

The canister can also include a pair of rails or supports 1184 that can be connected to a top portion 1186 of the outer wall 1106 to define the storage compartment 1123c. The storage compartment 1123c can be always open from the top and sides for quick and easy access to stored accessories, such as rollers, wheels, pads, cleaning solution, brushes, bags, or the like. In this way, the docking station 1100 can provide several types of storage for user-replaceable accessories or other items.

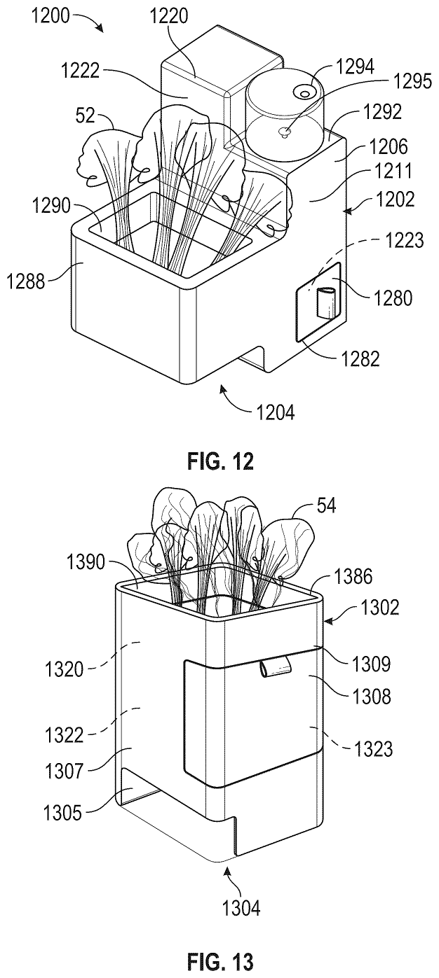

FIG. 12 illustrates a perspective view of a docking station 1200 for a mobile cleaning robot. The docking station 1200 can be similar to the docking stations 100-300 and 500-1100 discussed above. Any of the docking stations discussed above or below can be modified to include the features of the docking station 1200. The docking station 1200 can differ in that the docking station 1200 can include features for supporting a plant or plants.

The docking station 1200 can include a cannister 1202 connected to a base 1204 where the cannister 1202 can include an outer wall 1206 defining compartments, such as a debris bin or compartment 1220, a fan compartment 1222, and a storage compartments 1223. The base 1204 can be configured to receive a mobile cleaning robot therein or thereon. Optionally, the base 1204 can include a slot or be defined by a slot 1205 in the docking station 1200. The slot 1205 can be sized and shaped to receive a robot therein, such as for charging and debris evacuation.

The canister 1202 can include a drawer 1280 on a side portion 1211 of the outer wall 1206. The drawer 1280 can be slidably removable from the canister 1202 and can be insertable into a slot 1282 for storage. When the drawer 1280 is removed from the slot the storage compartment 1223 can be accessible. The storage compartment 1223 can be configured to store user-replaceable components for the robot or the docking station 1200, such as rollers, wheels, pads, cleaning solution, brushes, bags, or the like.

The canister 1202 can also include an extension 1288 that can extend forward from a back portion of the canister. The extension can include a recess 1290 therein. The recess 1290 can be a storage compartment configured to support, for example a plant 52. The canister 1202 can further include a platform 1292 configured to receive and retain a watering can 1294. The watering can 1294 can be removably connected to the platform 1292 and can be configured to store water for delivery to the recess 1290 for metered watering of the plant 52. The watering can 1294 can be fluidly connected to the recess by tubing, piping, or passageways 1295 through or in the canister 1202.

Though the extension 1288 and recess 1290 are discussed as being configured to support a plant, the extension and recess 1290 can support other items, such as a bowl of water for pets. Optionally, the water can 1294 can be omitted and the extension and recess 1290 can support other, dry items, such as user-replaceable accessories.

FIG. 13 illustrates a perspective view of a docking station for a mobile cleaning robot. The docking station 1300 can be similar to the docking stations 100-300 and 500-1200 discussed above. Any of the docking stations discussed above or below can be modified to include the features of the docking station 1300. The docking station 1300 can differ in that the docking station 1300 can include features for supporting a plant or plants.

The docking station 1300 can include a cannister 1302 connected to a base 1304 where the cannister 1302 can include an outer wall 1306 defining compartments, such as a debris bin or compartment 1320, a fan compartment 1322, and a storage compartments 1323. The base 1304 can be configured to receive a mobile cleaning robot therein or thereon. Optionally, the base 1304 can include a slot or be defined by a slot 1305 in the docking station. The slot 1305 can be sized and shaped to receive a robot therein, such as for charging and debris evacuation.

The storage compartment 1323 and the debris bin 1322 can be accessible when a lid 1308 is in an open position. The lid 1308 can be connected to a front portion 1309 of the outer wall 1306 such that the lid 1308 opens toward a front orientation of the docking station 1300. The lid 1308 can be hingeably connected to the outer wall 1306 at a bottom portion of the lid 1308 such that a user 50 does not have to hold the lid open to remove a bag from the debris bin 1320 or to remove a bag from the storage compartment 1323, such as for installation in the debris bin 1320. The storage compartment 1323 can be configured to store additional or alternative components, such as rollers, wheels, pads, cleaning solution, brushes, bags, or the like.

A top portion 1386 of the cannister 1302 can include or can define a recess 1390 that can be a storage compartment configured to support, for example a plant 54. The recess 1390 can be water-tight such that water or soil of the plant 54 does not escape the recess and move or migrate into the canister 1302. The recess 1390 can support other items, such as a bowl of water for pets, or other, dry items, such as user-replaceable accessories.

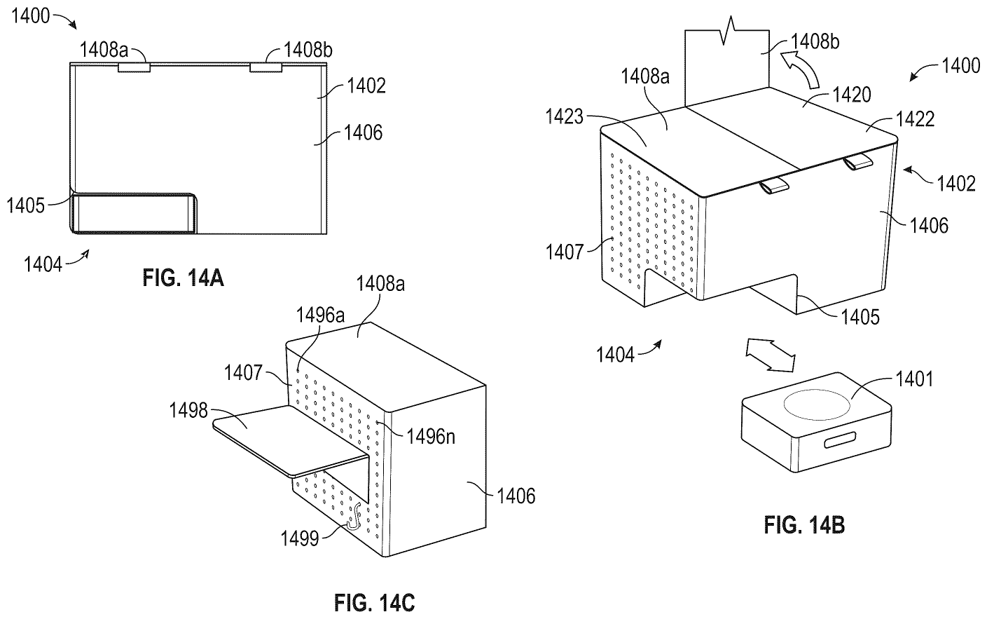

FIG. 14A illustrates a side view of a docking station 1400 for a mobile cleaning robot 1401. FIG. 14B illustrates a perspective view of the docking station 1400 and the mobile cleaning robot 1401. FIG. 14C illustrates an enlarged perspective view of a docking station for a mobile cleaning robot. FIGS. 14A-14C are discussed together below.

The docking station 1400 can be similar to the docking stations 100-300 and 500-1300 discussed above. Any of the docking stations discussed above or below can be modified to include the features of the docking station 1400. The docking station 1400 can differ in that the docking station 1400 can include an outer wall including or defining bores for attaching components thereto.

The docking station 1400 can include a cannister 1402 connected to a base 1404 where the cannister 1402 can include an outer wall 1406 defining compartments, such as a debris bin or compartment 1420, a fan compartment 1422, and a storage compartment 1423. The storage compartment 1423a can be configured to receive user-replaceable components, such as a side brush, debris bag, or the like. Optionally, the base 1404 can include a slot or be defined by a slot 1405 in the docking station. The slot 1405 can be sized and shaped to receive a robot therein, such as for charging and debris evacuation.

A lid 1408a can be connected to a top portion of the outer wall 1406 for access to, for example, the storage compartment 1423, which can be configured to store additional or alternative components, such as rollers, wheels, pads, cleaning solution, brushes, bags, or the like. A lid 1408b can be connected to a top portion of the outer wall (such as adjacent to the lid 1408b) and can be movable between an open position and a closed position, such as for access to the debris bin 1420 and the fan compartment 1422 when the lid 1408b is in the open position.

The outer wall 1406, such as a side portion 1407, can include or can define a plurality of holes or bores 1496a-1496n therein or therethrough. The holes or bores 1496 can be arranged in rows and columns or any other pattern. The holes or bores 1496 can optionally be slots, rails, or the like. The bores 1496 can be configured to support a shelf 1498 (such as through hooks or fasteners secured to the side portion 1407 via bores 1496). The bores 1496 can also be configured to support a hook 1499. The shelf 1498 or the hook 1499 can be configured to support user-replaceable accessories such as rollers, wheels, pads, cleaning solution, brushes, bags, or the like. For example, the hook 1499 can support a user-replaceable accessory hanging therefrom or can support a bag in which to store one or more user-replaceable accessories.

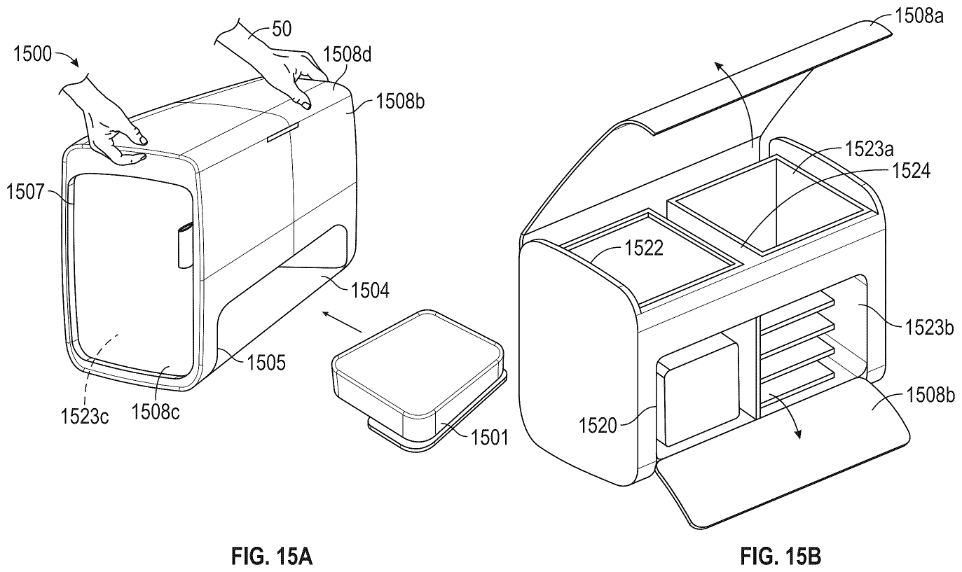

FIG. 15A illustrates a perspective view of a docking station 1500 and a mobile cleaning robot 1501. FIG. 15B illustrates a perspective view of the docking station 1500 and the mobile cleaning robot 1501. FIGS. 15A and 15B are discussed together below. The docking station 1500 can be similar to the docking stations 100-300 and 500-1400 discussed above. Any of the docking stations discussed above or below can be modified to include the features of the docking station 1500. The docking station 1500 can differ in that the docking station 1500 can include various storage compartments.

For example, the docking station 1500 can include a cannister 1502 connected to a base 1504 where the cannister 1502 can include an outer wall 1506 defining compartments, such as a debris bin or compartment 1520, a fan compartment 1522, and storage compartments 1523a and 1523b. The base 1504 can be configured to receive the mobile cleaning robot 1504 therein or thereon. Optionally, the base 1504 can include a slot or be defined by a slot 1505 in the docking station. The slot 1505 can be sized and shaped to receive the robot 1501 therein, such as for charging and debris evacuation.

A lid 1508a can be connected to a top portion of the outer wall 1506 such that the lid 1508a opens upward. The storage compartment 1523a and the fan compartment 1522 can be accessible when the lid 1508 is in an open position. The canister 1502 can include a second lid 1508b on a front portion 1509 of the outer wall 1506. The second lid 1508b can be hingeably connected to the outer wall 1506 such that when the lid 1508b is in a closed position, as shown in FIG. 15A, the storage compartment 1523b is closed or inaccessible. When the lid 1508b is in an open position, as shown in FIG. 15B, the storage compartment 1523b can be open and accessible through the front portion 1509 of the cannister 1502. Additionally, the debris bin 1520 can be accessible when the lid 1508b is in the open position. The storage compartment 1523b can be configured to store bags for replacement in the adjacent debris bin 1520.

A third lid 1508c can be connected to a side portion 1507 of the outer wall 1506. The lid 1508 can be movable between a closed position and an open position to access a storage compartment 1523c, which can be a third storage compartment for storing one or more user-replaceable accessories. The storage compartments 1523a-1523c can be configured to store additional or alternative components, such as rollers, wheels, pads, cleaning solution, brushes, bags, or the like.

The docking stations 100-300 and 400-1500 discussed above can include a means for storing a user-replaceable accessory associated with the base or the mobile cleaning robot. The means can be any of the storage compartments (223, 323, 523, 623, 723, 823, 923, 1023, 1123, 1223, 1323, 1423, 1523, or the bores and shelf or hooks of FIGS. 15A-15C.

### NOTES AND EXAMPLES

The following, non-limiting examples, detail certain aspects of the present subject matter to solve the challenges and provide the benefits discussed herein, among others.

Example 1 is a docking station for a mobile cleaning robot, the docking station comprising: a base configured to receive the mobile cleaning robot, the base including an electrical power interface configured to provide electrical power to the mobile cleaning robot; and a storage compartment, integrated with the base, the storage compartment sized and shaped to receive a user-replaceable accessory associated with the base or the mobile cleaning robot.

In Example 2, the subject matter of Example 1 optionally includes a canister connected to the base and located at least partially above the base, the canister comprising: a debris bin to receive debris from the mobile cleaning robot, the debris bin; and a bag compartment connected to the debris bin.

In Example 3, the subject matter of Example 2 optionally includes wherein the canister includes the storage compartment.

In Example 4, the subject matter of any one or more of Examples 2-3 optionally include a lid connected to the canister and movable between an open position and a closed position, the storage compartment and the bag compartment accessible when the lid is in the open position.

In Example 5, the subject matter of Example 4 optionally includes a tray supported by the canister, the tray accessible when the lid is in the open position.

In Example 6, the subject matter of Example 5 optionally includes wherein the tray includes a projection extending therefrom, the projection configured to interface with the replacement accessory to orient the replacement accessory within the tray and within the canister.

In Example 7, the subject matter of Example 6 optionally includes wherein the lid includes a recessed portion in alignment with the projection when the lid is in the closed position, the recessed portion configured to receive at least a portion of the replacement accessory when the replacement accessory is oriented by the projection and when the lid is in the closed position.

In Example 8, the subject matter of any one or more of Examples 5-7 optionally include the canister further comprising: a fan compartment connected to the bag compartment and including a fan system operable to draw debris through the debris bin and the bag compartment.

In Example 9, the subject matter of Example 8 optionally includes wherein the tray is connected to the fan compartment.

In Example 10, the subject matter of any one or more of Examples 8-9 optionally include wherein the tray is located above the fan compartment.

In Example 11, the subject matter of any one or more of Examples 9-10 optionally include wherein the tray is removably secured to the fan compartment by a snap interface.

In Example 12, the subject matter of any one or more of Examples 5-11 optionally include wherein the tray is removably securable to the canister by a magnetic interface.

Example 13 is a docking station for a mobile cleaning robot, the docking station comprising: a base configured to receive the mobile cleaning robot thereon, the base including a front portion and a back portion opposite the front portion; and a canister connected to the back portion of the base and located at least partially above the base, the canister comprising: a storage compartment configured to receive a user-replaceable accessory associated with the base or the mobile cleaning robot therein; and a lid connected to the canister and movable between an open position and a closed position, the storage compartment accessible when the lid is in the open position.

In Example 14, the subject matter of any one or more of Examples 11-13 optionally include wherein the base is configured to receive a mopping robot thereon.

In Example 15, the subject matter of any one or more of Examples 12-14 optionally include wherein the storage compartment is configured to store replacement mopping pads securable to the mopping robot.

In Example 16, the subject matter of any one or more of Examples 11-15 optionally include a debris bin to receive debris from the mobile cleaning robot when the mobile cleaning robot is connected to the base, the debris bin including a side wall at least partially enclosing the debris bin; and a bag compartment connected to the debris bin; wherein the storage compartment is separated from the debris bin and the bag compartment.

In Example 17, the subject matter of Example 16 optionally includes a tray supported by the canister, the tray accessible when the lid is in the open position.

In Example 18, the subject matter of Example 17 optionally includes wherein the tray includes a projection extending therefrom, the projection configured to interface with the replacement accessory to orient the replacement accessory within the tray and within the canister.

In Example 19, the subject matter of Example 18 optionally includes wherein the lid includes a recessed portion in alignment with the projection, the recessed portion configured to receive at least a portion of the replacement accessory when the replacement accessory is oriented by the projection and when the lid is in the closed position.

In Example 20, the subject matter of Example 19 optionally includes the canister further comprising: a fan compartment connected to the bag compartment and including a fan system operable to draw debris through the debris bin and the bag compartment; wherein the tray is connected to the fan compartment.

In Example 21, the subject matter of any one or more of Examples 11-20 optionally include wherein the lid is located on a top portion of the canister.

In Example 22, the subject matter of Example 21 optionally includes wherein the lid is located on a side portion of the canister.

In Example 23, the subject matter of any one or more of Examples 21-22 optionally include wherein the lid is located on a back portion of the canister.

In Example 24, the subject matter of any one or more of Examples 11-23 optionally include a debris bin to receive debris from the mobile cleaning robot when the mobile cleaning robot is connected to the base, the debris bin including a side wall at least partially enclosing the debris bin; a bag compartment connected to the debris bin; and a debris lid connected to a top portion of the canister and movable between an open and a closed position, the bag compartment accessible when the lid is in the open position.

In Example 25, the subject matter of Example 24 optionally includes wherein the debris lid is located on a side portion of the canister.

In Example 26, the subject matter of Example 25 optionally includes wherein the debris lid is located on a back portion of the canister.

In Example 27, the subject matter of any one or more of Examples 11-26 optionally include the canister further comprising: a fan compartment connected to the bag compartment and including a fan system operable to draw debris through the debris bin and the bag compartment; wherein the canister includes a plurality of openings extending therethrough and into the fan compartment, the plurality of openings configured to exhaust air from the fan system.

In Example 28, the subject matter of Example 27 optionally includes the canister further comprising: a hook feature securable to any of the plurality of openings, the hook feature configured to support an accessory hanging therefrom.

In Example 29, the subject matter of any one or more of Examples 27-28 optionally include wherein the user-replaceable accessory is one of a side brush, a filter, a cleaning pad, cleaning solution, a roller, or an evacuation bag.

Example 30 is a docking station for a mobile cleaning robot, the docking station comprising: a base configured to receive the mobile cleaning robot, the base including an electrical power interface configured to provide electrical power to the mobile cleaning robot; and a canister connected to the base and located at least partially above the base, the canister comprising: a means for storing a user-replaceable accessory associated with the base or the mobile cleaning robot.

In Example 31, the subject matter of Example 30 optionally includes a canister connected to the base and located at least partially above the base, the canister comprising: a debris bin to receive debris from the mobile cleaning robot, the debris bin; and a bag compartment connected to the debris bin.

In Example 32, the subject matter of Example 31 optionally includes wherein the canister includes the means for storing a user-replaceable accessory.

In Example 33, the subject matter of Example 32 optionally includes a lid connected to the canister and movable between an open position and a closed position, the means for storing a user-replaceable accessory and the bag compartment accessible when the lid is in the open position.

In Example 34, the subject matter of Example 33 optionally includes a tray supported by the canister, the tray accessible when the lid is in the open position.

In Example 35, the subject matter of Example 34 optionally includes wherein the tray includes a projection extending therefrom, the projection configured to interface with the replacement accessory to orient the replacement accessory within the tray and within the canister.

In Example 36, the subject matter of Example 35 optionally includes wherein the lid includes a recessed portion in alignment with the projection when the lid is in the closed position, the recessed portion configured to receive at least a portion of the replacement accessory when the replacement accessory is oriented by the projection and when the lid is in the closed position.

In Example 37, the apparatuses or method of any one or any combination of Examples 1-36 can optionally be configured such that all elements or options recited are available to use or select from.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A docking station for a mobile cleaning robot, the docking station comprising:
a base configured to receive the mobile cleaning robot, the base including an electrical power interface configured to provide electrical power to the mobile cleaning robot;
a canister connected to the base and located at least partially above the base, the canister comprising:
a debris bin to receive debris from the mobile cleaning robot, the debris bin including a vacuum inlet;
a bag compartment connected to the debris bin configured to support a bag connected to the vacuum inlet; and
a storage compartment, integrated with the base, the storage compartment sized and shaped to receive a end-user-replaceable accessory associated with the base or the mobile cleaning robot; and
a tray supported by the canister, the tray including a projection extending therefrom, the projection configured to interface with the end-user-replaceable accessory to orient the end-user-replaceable accessory within the tray and within the canister.

2. The docking station of claim 1, further comprising:
a lid connected to the canister and movable between an open position and a closed position, the storage compartment, the tray, and the bag compartment accessible when the lid is in the open position.

3. The docking station of claim 2, wherein the lid includes a recessed portion in alignment with the projection when the lid is in the closed position, the recessed portion configured to receive at least a portion of the end-user-replaceable accessory when the end-user-replaceable accessory is oriented by the projection and when the lid is in the closed position.

4. The docking station of claim 3, the canister further comprising:
a fan compartment connected to the bag compartment and including a fan system operable to draw debris through the debris bin and the bag compartment.

5. The docking station of claim 4, the canister further comprising:
a fan compartment cover connected to the canister and located between the tray and the fan compartment when the tray is connected to the canister.

6. The docking station of claim 5, wherein the tray includes a tab extending from a bottom portion of the tray and insertable into an opening of the fan compartment cover to orient the tray with respect to the fan compartment and to connect the tray to the canister.

7. The docking station of claim 5, wherein the tray includes a plurality of tabs each extending from a bottom portion of the tray and each insertable into a plurality of openings of the fan compartment cover to orient the tray with respect to the fan compartment and to connect the tray to the canister.

8. The docking station of claim 7, wherein the tray includes a notch configured to receive a tool therein for prying of the tray to disengage the plurality of tabs from the plurality of openings of the fan compartment cover.

9. The docking station of claim 4, wherein the tray is located above the fan compartment.

10. The docking station of claim 4, wherein the tray is removably secured to the fan compartment by a snap interface.

11. The docking station of claim 4, wherein the tray is removably securable to the canister by a magnetic interface.

12. A docking station for a mobile cleaning robot, the docking station comprising:
a base configured to receive the mobile cleaning robot at least partially therein or thereon, the base including an electrical power interface configured to provide electrical power to the mobile cleaning robot;
a canister connected to the base and located at least partially above the base, the canister comprising:
a debris bin to receive debris from the mobile cleaning robot;
a bag compartment connected to the debris bin configured to support a bag connected thereto; and
a storage compartment sized and shaped to receive a user-replaceable accessory associated with the base or the mobile cleaning robot;
a tray supported by the canister at least partially withing the storage compartment; and
a lid connected to the canister and movable between an open position and a closed position, the storage compartment, the tray, and the bag compartment accessible when the lid is in the open position, the lid including a recessed portion configured to receive at least a portion of the user-replaceable accessory when the user-replaceable accessory is locate within the storage compartment.

13. The docking station of claim 12, wherein the tray includes a projection extending therefrom, the projection configured to interface with the user-replaceable accessory to orient the user-replaceable accessory within the tray and within the canister.

14. The docking station of claim 13, wherein the recessed portion is in alignment with the projection when the lid is in the closed position.

15. The docking station of claim 12, the canister further comprising:
a fan compartment connected to the bag compartment and including a fan system operable to draw debris through the debris bin and the bag compartment.

16. The docking station of claim 15, the canister further comprising:
a fan compartment cover connected to the canister and located between the tray and the fan compartment when the tray is connected to the canister.

17. The docking station of claim 16, wherein the tray includes a plurality of tabs each extending from a bottom portion of the tray and each insertable into a plurality of openings of the fan compartment cover to orient the tray with respect to the fan compartment and to connect the tray to the canister.

18. The docking station of claim 17, wherein each tab of the plurality of tabs includes a finger configured to engage the fan compartment cover to secure the tray to the fan compartment cover.

19. The docking station of claim 18, wherein the tray includes a notch configured to receive a tool therein for prying of the tray to disengage the plurality of tabs from the plurality of openings of the fan compartment cover.

20. The docking station of claim 19, wherein the tray is removably securable to the canister by a magnetic interface.
